(19) United States
(12) Patent Application Publication
(10) Pub. No.: US 2020/0127740 A1
(43) Pub. Date: Apr. 23, 2020

(54) MITIGATION OF PERIODIC NOISE IN COMMUNICATION

(71) Applicant: ZTE Corporation, Shenzhen (CN)

(72) Inventors: Jianjun Yu, Basking Ridge, NJ (US); Yun Zhang, Beijing (CN); Rui Deng, Beijing (CN); Xiangjun Xin, Beijing (CN); Yufei Chen, Beijing (CN)

(21) Appl. No.: 16/654,983

(22) Filed: Oct. 16, 2019

(30) Foreign Application Priority Data
Oct. 17, 2018 (CN) PCT/CN2018/110625

(51) Int. Cl. H04B 10/61; H04B 10/079; H04L 5/00; H04J 14/06; H04B 10/11; H04B 1/00

(52) U.S. Cl. CPC H04B 10/6166; H04B 10/0795; H04B 1/0003; H04J 14/06; H04B 10/11; H04L 5/0007

(57) ABSTRACT

A communication receiver receives a signal sample stream of an orthogonal frequency division multiplexing (OFDM) signal, splits the signal sample stream into blocks, where each block corresponds to a symbol or a gap of the OFDM signal, determines an estimate of a periodic noise in the OFDM signal by averaging signal samples over a number of blocks, generates a noise-suppressed signal by subtracting the estimate of the periodic noise from the signal sample stream, and performs further receiver-side processing on the noise-suppressed signal.

### CROSS REFERENCE TO RELATED APPLICATIONS

This patent document claims the benefit of priority under 35 U.S.C. § 119(a) and the Paris Convention of International Patent Application No. PCT/CN2018/0110625, filed Oct. 17, 2018. The entire content of the before-mentioned patent application is incorporated by reference as part of the disclosure of this application.

### TECHNICAL FIELD

The present document relates to digital communication and, in particular, to receiver-side signal processing.

### BACKGROUND

The wide-spread adoption of internet services including video streams and peer to peer (P2P) interactive applications, among others, has driven the demand of high transmission capacity of optical systems. Among the many solutions available, an optical wireless integration (OWI) has emerged to meet the demand of both high speed and flexibility through combining high capacity optical network and flexible wireless access network. However, as the bandwidth demand in the wireless network increases drastically, wireless technologies continue to evolve. Therefore, numerous challenges need to be addressed to deploy the OWI networks efficiently.

### SUMMARY

The present document discloses techniques for wireless communication including, in some embodiments, techniques for mitigation or suppression of periodic noise in a received communication signal.

In one example aspect, a digital communication method is disclosed. Using the method, a communication receiver receives a signal sample stream of an orthogonal frequency division multiplexing (OFDM) signal, splits the signal sample stream into blocks, where each block corresponds to a symbol or a gap of the OFDM signal, determines an estimate of a periodic noise in the OFDM signal by averaging signal samples over a number of blocks, generates a noise-suppressed signal by subtracting the estimate of the periodic noise from the signal sample stream, and performs further receiver-side processing on the noise-suppressed signal.

In another aspect, a digital communication method is disclosed. The method includes receiving, over a wireless interface, an OFDM signal that is generated from an optical signal that comprises I-Q modulated information bits, generating a signal sample stream by performing analog-to-digital conversion of the OFDM signal, wherein each symbol of the OFDM signal corresponds to N samples of the signal sample stream, determining N noise values by averaging N samples of symbols of the OFDM signal over a frame of the OFDM signal, determining noise-suppressed signal values by subtracting the N noise values from N samples of each symbol, and using the noise-suppressed signal values to recover the information bits.

In another aspect, a communication apparatus for implementing the above-described methods is disclosed.

These and other aspects, and example implementations and variations are set forth in the drawings, the description and the claims.

### BRIEF DESCRIPTION OF THE DRAWINGS

FIG. 1 pictorially depicts an example of effects of removing periodic noise from a communication signal.

FIG. 2 shows an example of an embodiment of an end-to-end communication system.

FIG. 3A-3B show results achieved in one example embodiment.

FIG. 4 is a flowchart for an example method of optical communication.

FIG. 5 is a block diagram of an example communication apparatus.

FIG. 6 shows an example embodiment of an optical-wireless communication network in which the presently disclosed technology can be embodied.

FIG. 7 is a flowchart for an example method of digital communication.

### DETAILED DESCRIPTION

Section headings are used in the DETAILED DESCRIPTION section only for improved readability and do not limit scope of the disclosed embodiments or techniques to the corresponding section. Accordingly, embodiments and techniques from different sections may be implemented together as described in the present document and in the claims.

In the past tens of years, optical communication technology has achieved significant improvements in reducing complexity while increasing the bandwidth throughput of optical communication. Various optical transmission systems have been deployed to serve real world networks and are carrying data traffic for end user productivity and enjoyment. For example, coherent optical fiber systems are presently being used in core networks to increase regional communication speeds. As another example, intensity modulation direct detection optical fiber systems are being used in access networks to provide high bandwidth service for end users such as residential customers. Moreover, new optical transmission systems such as ones implementing a combination of fiber-wireless system and optical wireless system, have received much attention in recent years. Although such systems are still in labs and under experimentation, enormous potential have been demonstrated for that those kinds of system can be used in future communication systems.

In some respects, the optical communication channel is much better than pure wireless communication channel. For example, in comparison with a wireless channel, an optical channel experiences low-to-none Electro-Magnetic Interference (EMI) would affect the signal transmitted in optical communication channel.

One example of EMI that is often experienced by wireless channels is periodic noise that ingresses a communication signal from electronic circuits and other electrical activity near the wireless channel over which the communication signal propagates. However, due to the immunity from ambient EMI, in general, EMI-caused by periodic noise are not taken into consideration when designing an optical transmission system regardless of the communication environment around the optical transmission medium.

Nevertheless, nowadays, some high-speed optical fiber systems are based on advanced digital signal processing (DSP), and may use analog-to-digital converter (ADC) to perform signal processing in the digital domain.

An ADC circuit often uses a clock signal and may generate a clock noise at harmonics of a local oscillator. This is a periodic noise and may degrade performance of the optical system utilizing the ADC. In addition, in a low-complexity optical wireless transmission system such as one that uses visible light for communication, if a low-cost non-ideal power supplier is used, periodic noise such as periodic power impulse noise may also be present, further degrading throughput or bit error rate performance of the optical communication.

The present document provides several techniques that may be used in optical receiver embodiments to address the above-discussed degradations caused by periodic noise, among other problems. For example, in some receiver embodiments, a signal processing method may use time-domain partition-averaging as described herein.

Examples of Operational Principles

In some embodiments, a receiver apparatus may implement at least the following signal processing steps. In Step 1, the receiver may perform noise estimation. In some implementations, the noise estimation may be performed by signal averaging. In Step 2, the receiver may perform noise mitigation by subtracting out the noise estimate from the received signal, thereby resulting in a noise-suppressed received signal.

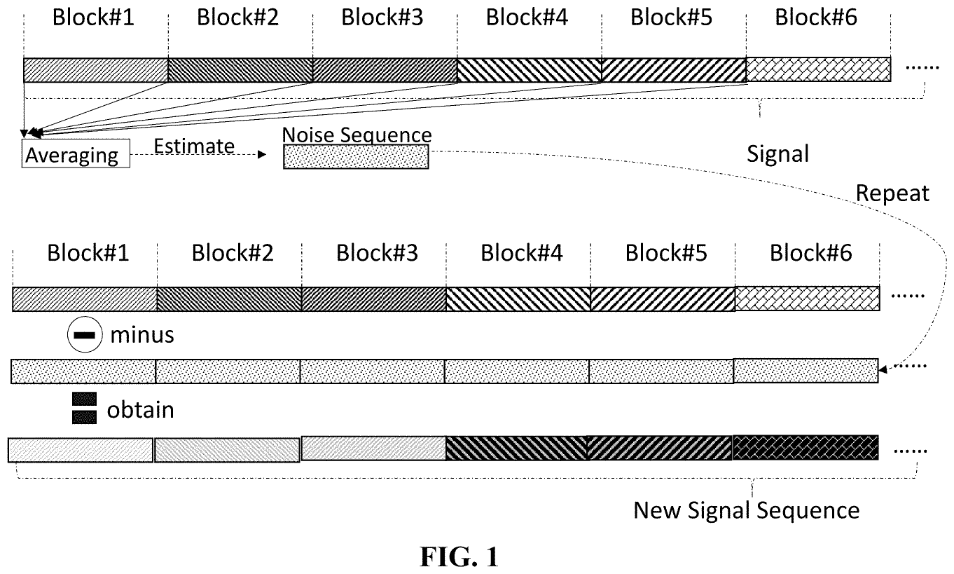

FIG. 1 provides a graphical depiction of an example process of noise estimation and mitigation.

Signal received at the receiver is represented along the horizontal time axis as blocks of signals (Block 1 to Block 6). The progression of signal processing is represented along the downwards directions.

Step. 1 Averaging and Noise Estimation

In the first step, the receiver may organize the received signal as a number of blocks of equal time durations that consecutively follow each other. These blocks may averaged together and the result of averaging may be used as an estimate of the periodic noise present in the received signal. In some embodiments, a time window low pass filtering (e.g., a triangular weighted lowpass filter) may be used by which recent samples receive a greater weight compared to past signal samples.

The simple averaging technique may be mathematically represented as follows. Here, for simplicity of explanation, an orthogonal frequency division multiplexing (OFDM) modulation scheme is assumed.

$$N ( i ) = \{ \begin{matrix}1 / {N}_{iteration} {\sum }_{k = 1}^{{N}_{iteration}} S ( i + {kN}_{block} - {N}_{block} ) , & i = 1 , 2 , … , {N}_{block} \\ 0 , & otherwise\end{matrix} \qquad ( 1 )$$

In Equation (1), S( ) are digital samples of the received signal, k is an integer, Nᵢₜₑᵣₐₜᵢₒₙ is a number representing number of signal blocks used for noise estimation. The variable i is used as an index to samples. N_{block} represents number of samples in each block of signal samples. The left-hand side term N(i) represents an estimate of noise at the ith sample position in the signal block.

While Equation (1) shows simple averaging, in other embodiments, time-dependent weights may also be used for the summation.

Step 2: Noise Mitigation

In the second step, as depicted in FIG. 1, the estimated noise is subtracted from the signal samples, thereby resulting in the noise-suppressed received signal R(k). As can be seen from the equation below, the N_{block} number of noise estimates of the periodic signal are used.

R(i)=S(i)−N(k),k=Mod(i,N_{block})+1 (2)

The noise-suppressed signal R(i) is then used for subsequent receiver-side processing such as OFDM demodulation.

In a practical optical communication system, signal values are typically normally Gaussian-like random signals with zero mean value. For signals with such statistics, the periodic noise can be estimated by partitioning the signal and then averaging each partitioned block as discussed above. Furthermore, the electronic circuitry used for reception of OFDM signals often uses clocks that are multiples of symbol rates and/or sample rates based on the dimensionality of the inverse fast Fourier transform (IFFT) used during the reception and decoding of the OFDM signal. Therefore, effective noise suppression can be achieved by average similarly located samples of the signal across different symbols. For example, first samples of each symbol may be averaged to obtain a first sample of noise estimate, second samples of each symbol may be averaged to obtain a second sample of noise estimate, and so on, until all samples of each symbol are averaged to obtain a corresponding number of estimates of noise values. This process may be repeated over all symbols in a frame of OFDM signal or may use multiple OFDM frames for noise averaging. Embodiments may be deployed for trading off the effectiveness of noise suppression versus the responsiveness of noise suppression. For example, noise averaging over a long duration (e.g., 5 to 10 frames) may provide a better estimate of the periodic noise, but may be slow in responding to frame-by-frame variations in the periodic noise. Alternatively, noise averaging on a per-frame basis may prove effective to suppress periodic noise on a period-by-period basis and also avoid delay in processing of received samples.

Example Experimental Setup

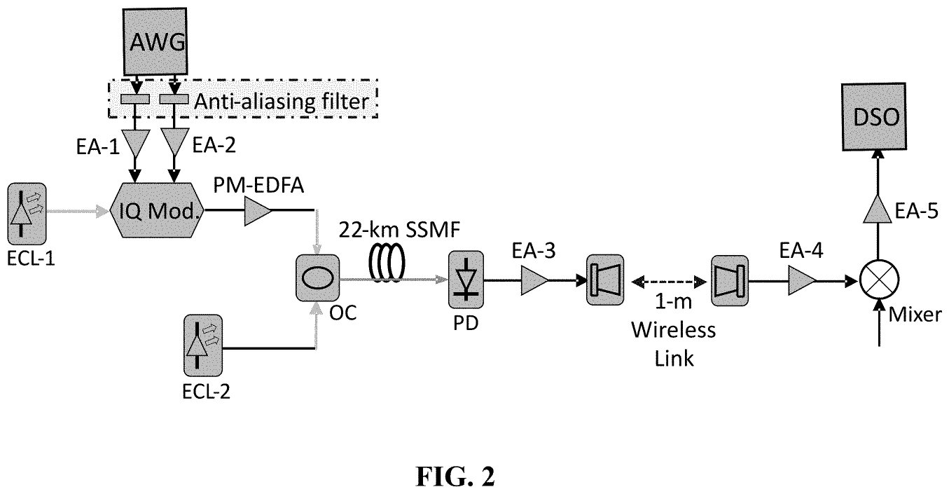

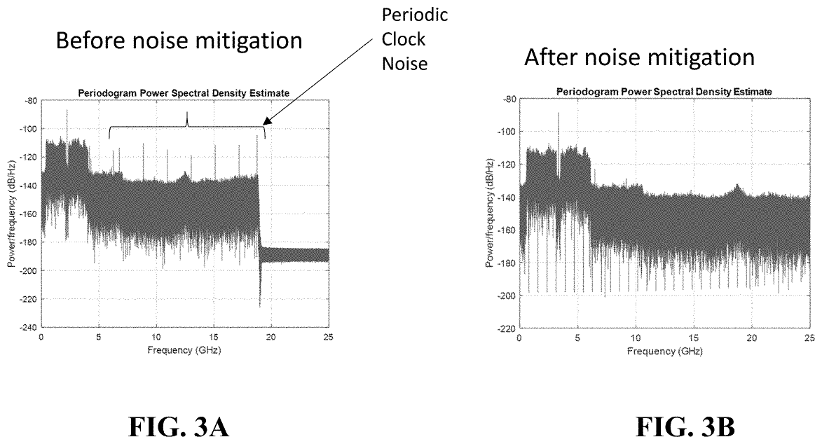

FIG. 2 shows an example experimental setup using which the results depicted in FIG. 3A and FIG. 3B were obtained.

In FIG. 2, signal flows from the left side (transmitter-side) to the right side (receiver-side) over a transmission channel that includes an optical channel such as a 22-km single mode optical fiber (SSMF). A wireless link is optionally included as a part of the transmission channel for test purpose.

A signal is generated for transmission using an additive white gaussian noise source AWG. In a practical system, signal source may include information bits at the transmitter-side. The information bits may be, for example, user data from one or more user devices, or control messages, and so on. The AWG may provide two data streams—one for I modulation and the other for Q modulation. An anti-aliasing lowpass filter may be used to filter the samples generated from the AWG to ensure that the subsequent transmission does not introduce aliasing artifacts in the received signal. The AWG and the anti-aliasing filters may be operating in the electrical domain. The resulting anti-aliased signals may be amplified through an electrical domain amplifier (EA) and fed to an optical modulator that uses output laser of a laser source such as an external cavity laser (ECL-1) to produce an optical signal. The IQ modulation may be perform using equipment such as a Mach Zehnder Modulator (MZM). The resulting optical signal may be passed through an amplifier such as a polarization maintaining Erbium doped fiber amplifier (PM-EDFA). A second laser source (ECL-2) is used to generate an optical carrier wavelength and is optically coupled with an output of the IQ-modulator, having undergone the optional amplification, to produce an optical signal for transmission.

As previously mentioned, the transmission channel may include fiber-only or a combined wireless and fiber channel. In the experimental setup depicted in FIG. 2, a one meter wireless link was used. The optical signal generated from the output of the optical coupler (OC) may be converted to electrical domain using, for example, a photodiode (PD) and subsequently optionally amplified using EA-3 and fed into an antenna for wireless transmission. The wireless transmission may use OFDM, as discussed above. The details of mapping the electrical signal to OFDM symbols is routine, and is omitted for brevity.

At the receiver, a wireless receiving antenna may receive the transmitted signal. An amplifier EA-4 may be used for amplifying the received signal, followed by a mixer stage in which the mixer may be used to downconvert the received signal to a lower or baseband frequency. In the experimental setup, a Lecroy digital spectrum analyzer (DSO) with 50 Gbps sampling rate was used for converting analog signal into digital domain and performing subsequent digital signal processing that includes the noise estimation and noise mitigation steps.

For the experiment, the mixer was selected to have wide bandwidth characteristics such that the periodic noise only was due to the OFDM modulation and the mixer circuitry did not contribute any additional periodic noise.

For the OFDM transmission, the following parameters for the signal generation as shown as Table 1 were used.

TABLE 1

| Parameter | Value |
|---|---|
| Mapping scheme | 16-QAM |
| IFFT size | 512 points |
| Cyclic prefix (CP) length | 16 points |
| The location of the data-carrying sub-carriers | 16-th-226-th subcarriers & |
| | 308-th~498-th subcarriers |
| The number of OFDM symbols per frame | 50 |
| The number of training symbol per OFDM | 1 |
| frame | |
| Gap between two OFDM frames | 1 symbol (528 points) |

FIG. 3A and FIG. 3B show spectra of signals without using periodic noise mitigation and with using periodic noise mitigation, observed at the receiver.

The horizontal axes in FIG. 3A-3B represent frequency in GHz and the vertical axes represent recorded signal power in dB/Hz. The curves depict measured power spectral density of the received OFDM signal. In FIG. 3A, signal spikes due to the presence of periodic noise are visible. By contrast, no such periodic noise is present in the spectrum depicted in FIG. 3B due to the use of noise estimation/mitigation as described in the present document. Therefore, the advantage of the presently disclosed periodic noise mitigation technique is evident from these spectra.

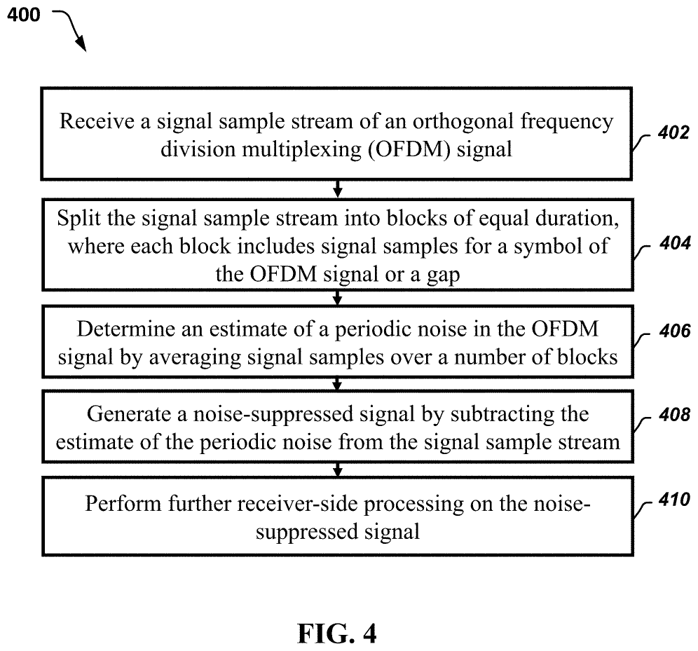

FIG. 4 is a flowchart for a method 400 of receiving a communication signal implemented by a communication receiver. Using the method 4000, the communication receiver receives (402) a signal sample stream of an orthogonal frequency division multiplexing (OFDM) signal, splits (404) the signal sample stream into blocks, where each block corresponds to a symbol or a gap of the OFDM signal, determines (406) an estimate of a periodic noise in the OFDM signal by averaging signal samples over a number of blocks, generates (408) a noise-suppressed signal by subtracting the estimate of the periodic noise from the signal sample stream, and performs (410) further receiver-side processing on the noise-suppressed signal.

In various embodiments, the communication receiver that implements the method 400 may be operated in a wireless system or an optical system. For example, in the wireless system, the communication receiver may use the method 400 to receive a wireless OFDM signal and recover information bits modulated onto the OFDM symbols. For example, in an optical communication system, the communication receiver may implement the method 400 to receive OFDM modulated signals and recover information bits from the signal.

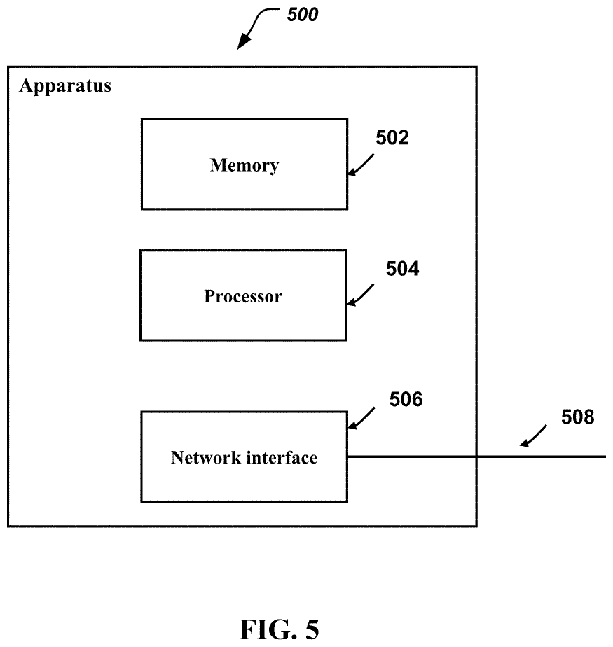

FIG. 5 is a block diagram of an example communication apparatus 500. The apparatus 500 may include one or more memories 502, one or more processors 504 and a network interface front end 506 communicatively coupled to a communication link 508. The one or more memories 502 may store processor-executable instructions and/or data during processor operation. The one or more processors 504 may read instructions from the one or memories 502 and implement a technique described in the present document. The apparatus 500 may implement various methods including the method 400 or 700.

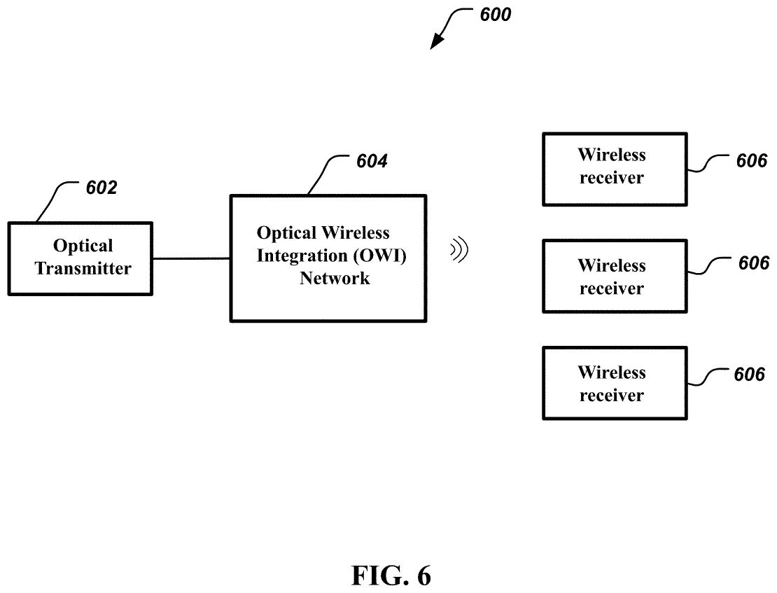

FIG. 6 shows an example embodiment of an optical communication network 600 in which the presently disclosed technology can be embodied. One or more optical transmitters 602 are communicatively coupled via an optical wireless integration (OWI) network 604 with one or more wireless receivers 606. Optical signals transmitted to the OWI network may go through intermediate optical equipment such as amplifiers, repeaters, switch, etc., which are not shown in FIG. 6 for clarity. Furthermore, the over-the-air transmission embodiments described herein are also omitted from the transmission path (typically located within the optical network 604) of FIG. 6 for clarity.

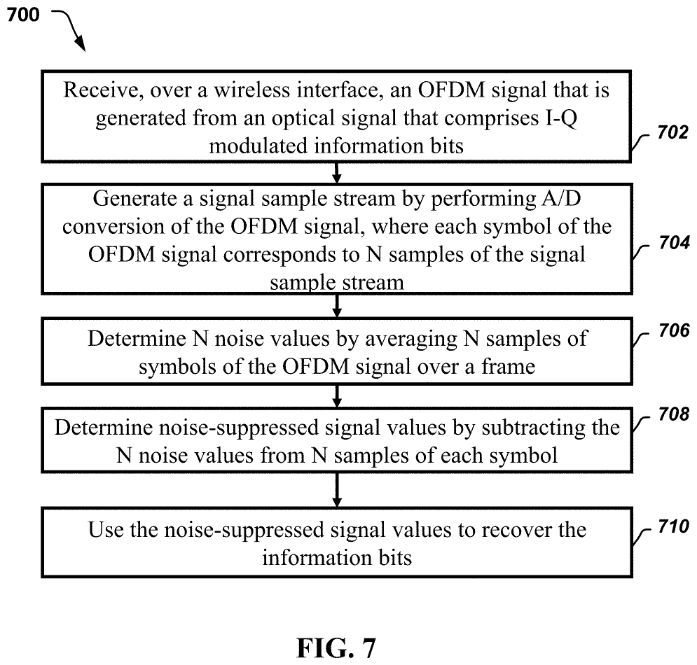

FIG. 7 is a flowchart for a method 700 of digital communication. The method 700 includes receiving (702), over a wireless interface, an OFDM signal that is generated from an optical signal that comprises I-Q modulated information bits, generating (704) a signal sample stream by performing analog-to-digital conversion of the OFDM signal, where each symbol of the OFDM signal corresponds to N samples of the signal sample stream, determining (706) N noise values by averaging N samples of symbols of the OFDM signal over a frame of the OFDM signal, determining (708) noise-suppressed signal values by subtracting the N noise values from N samples of each symbol, and using (710) the noise-suppressed signal values to recover the information bits. Here, N is an integer and may corresponds to number of IFFT output samples of each symbol (e.g., N_{block} as discussed with respect to Equations (1) and (2).

With respect to the methods 400 and 700, in some embodiments, noise averaging may be performed over multiple symbols. For example, averaging may be performed over 2, 3 or 4 symbols, depending on an estimate of periodicity of the noise that is entering the transmission channel.

In the methods 400 or 700, the signal stream may be generated by digitizing, using an analog to digital convertor circuit, a transmission received over a wireless channel. In some implementations, multiple polarization component signals in the optical domain may be used and a corresponding multi-input-multi-output (MIMO) configuration may be used when converting the multiple polarization components into corresponding multiple OFDM component signals.

In some embodiments of the method 400 or 700, in place of a simple averaging (which is effectively a lowpass filter with each filter tap having equal value), a lowpass filter of another type may be used to spectrally shape the noise estimate. For example, a lowpass filter with better lowpass response may be used instead of averaging to eliminate higher frequency computational noise due to quantization and rounding.

In some embodiments of the methods 400 or 700, the OFDM signal may comprise symbols that include a cyclic prefix followed by data subcarriers. Furthermore, a gap may be used between OFDM frames.

The methods 400 and 700 may further include a demodulation operation in which the noise-suppressed signal values are then demodulated and decoded (e.g., to remove forward error code and the like) to recover information bits carried in the received OFDM signal.

It will be appreciated that techniques for noise mitigation particularly directed at periodic noise that may be present in an optical transmission system are disclosed. It will further be appreciated that some embodiments of the disclosed technique may use computationally inexpensive techniques such as splitting or partitioning data in blocks and performing simple averaging of the data (e.g., by accumulate scaling based on a factor of two number of samples). It will thus be appreciated that the disclosed techniques may be implemented with minimal additional computational burden, and yet at the same time, provide an effective way to suppress or eliminate periodic noise that enters a digitized communication signal due to clocks used in the implementation circuitry.

The disclosed and other embodiments and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of communication, comprising:
receiving a signal sample stream of an orthogonal frequency division multiplexing (OFDM) signal;
splitting the signal sample stream into blocks, wherein each block corresponds to a symbol or a gap of the OFDM signal;
determining an estimate of a periodic noise in the OFDM signal by averaging signal samples over a number of blocks;
generating a noise-suppressed signal by subtracting the estimate of the periodic noise from the signal sample stream; and
performing further receiver-side processing on the noise-suppressed signal.

2. The method of claim 1, wherein the signal sample stream is generated by digitizing, using an analog to digital convertor circuit, a transmission received over a wireless channel.

3. The method of claim 2, wherein the transmission includes multiple polarization component signals that are multiplexed using polarization division multiplexing.

4. The method of claim 1, wherein the averaging comprises using a lowpass finite impulse response (FIR) filter over the number of blocks.

5. The method of claim 1, wherein the performing further receiver-side processing includes performing symbol demodulation to recover transmitted information bits.

6. The method of claim 1, wherein, for each block, a corresponding signal sample stream includes a data carrying portion and a cyclic prefix portion.

7. The method of claim 1, wherein the gap and symbols have a same duration.

8. A communication signal transmission apparatus, comprising a processor, the processor configured to implement a method, comprising:
receiving a signal sample stream of an orthogonal frequency division multiplexing (OFDM) signal;
splitting the signal sample stream into blocks, wherein each block corresponds to a symbol or a gap of the OFDM signal;
determining an estimate of a periodic noise in the OFDM signal by averaging signal samples over a number of blocks;
generating a noise-suppressed signal by subtracting the estimate of the periodic noise from the signal sample stream; and
performing further receiver-side processing on the noise-suppressed signal.

9. The apparatus of claim 8, wherein the signal sample stream is generated by digitizing, using an analog to digital convertor circuit, a transmission received over a wireless channel.

10. The apparatus of claim 9, wherein the transmission includes multiple polarization component signals that are multiplexed using polarization division multiplexing.

11. The apparatus of claim 8, wherein the averaging comprises using a lowpass finite impulse response (FIR) filter over the number of blocks.

12. The apparatus of claim 8, wherein the performing further receiver-side processing includes performing symbol demodulation to recover transmitted information bits.

13. A digital communication method, comprising:
receiving, over a wireless interface, an orthogonal frequency division multiplexing (OFDM) signal that is generated from an optical signal that comprises I-Q modulated information bits;
generating a signal sample stream by performing analog-to-digital conversion of the OFDM signal, wherein each symbol of the OFDM signal corresponds to N samples of the signal sample stream;
determining N noise values by averaging N samples of symbols of the OFDM signal over a frame of the OFDM signal;
determining noise-suppressed signal values by subtracting the N noise values from N samples of each symbol; and
using the noise-suppressed signal values to recover the information bits.

14. The method of claim 13, wherein the averaging comprises using a lowpass finite impulse response (FIR) filter over the frame of the OFDM signal.

15. The method of claim 13, wherein the using the noise-suppressed signal values to recover the information bits includes performing OFDM demodulation of the noise-suppressed signal.
